(19) United States
(12) Patent Application Publication
(10) Pub. No.: US 2005/0027050 A1
(43) Pub. Date: Feb. 3, 2005

(54) Laser sinter powder with a metal salt and a fatty acid derivative, process for its production, and moldings produced from this laser sinter powder

(75) Inventors: Sylvia Monsheimer, Haltern am See (DE); Maik Grebe, Bochum (DE); Franz-Erich Baumann, Dulmen (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: DEGUSSA AG, Marl (DE)

(21) Appl. No.: 10/901,204

(22) Filed: Jul. 29, 2004

(30) Foreign Application Priority Data
Jul. 29, 2003 (DE) 103 34 496.9

(51) Int. Cl. C08K 5/04; C08K 5/20

(52) U.S. Cl. 524/230; 524/394

(57) ABSTRACT

The present invention relates to a sinter powder composed of polyamide which also comprises metal salts of weak acids, in particular metal carbonates, and fatty acid derivatives, in particular fatty acid esters or fatty acid amides, to a process for laser sintering, and also to moldings produced from this sinter powder. The moldings formed using the powder of the invention have marked advantages in appearance and in surface finish when compared with conventional products, especially when recyclability in the selective laser sintering (SLS) process is taken into account. Moldings produced from recycled sinter powder of the invention moreover also have markedly improved mechanical properties when compared with moldings based on recycled conventional nylon-12 powders, in particular in terms of modulus of elasticity and tensile strain at break. These moldings also have a density approaching that of injection moldings.

### BACKGROUND OF THE INVENTION

1. Field of the Invention

The invention relates to a laser sinter powder based on polyamide, preferably nylon-12, which comprises metal salt (particles) and a fatty acid derivative, to a process for producing this powder, and also to moldings produced by selective laser sintering of this powder.

2. Discussion of the Background

Very recently, a requirement has arisen for the rapid production of prototypes. Selective laser sintering is a process particularly well suited to rapid prototyping. In this process, polymer powders in a chamber are selectively irradiated briefly with a laser beam, resulting in melting of the particles of powder on which the laser beam falls. The molten particles fuse and solidify again to give a solid mass. Three-dimensional bodies can be produced simply and rapidly by this process, by repeatedly applying fresh layers and irradiating these.

The process of laser sintering (rapid prototyping) to realize moldings made from pulverulent polymers is described in detail in the patent specifications U.S. Pat. No. 6,136,948 and WO 96/06881 (both DTM Corporation). A wide variety of polymers and copolymers is claimed for this application, e.g. polyacetate, polypropylene, polyethylene, ionomers, and polyamide.

Nylon-12 powder (PA 12) has proven particularly successful in industry for laser sintering to produce moldings, in particular to produce engineering components. The parts manufactured from PA 12 powder meet the high requirements demanded with regard to mechanical loading, and therefore have properties particularly close to those of the mass-production parts subsequently produced by extrusion or injection molding.

A PA 12 powder with good suitability here has a median particle size (d₅₀) of from 50 to 150 μm, and is obtained as in DE 197 08 946 or else DE 44 21 454, for example. It is preferable here to use a nylon-12 powder whose melting point is from 185 to 189° C., whose enthalpy of fusion is 112 J/g, and whose freezing point is from 138 to 143° C., as described in EP 0 911 142.

Disadvantages of the polyamide powders currently used are depressions, and also rough surfaces on the moldings, these arising during the reuse of unsintered material. The result of this is a need to add a high proportion of fresh powder, known as virgin powder, to eliminate these effects.

This effect is particularly evident when large proportions of recycled powder are used, this being laser sinter powder which has been used before but not melted during that use. The surface defects are often associated with impairment of mechanical properties, particularly if a rough surface is generated on the molding. The deterioration can become apparent in a lowering of modulus of elasticity, impaired tensile strain at break, or impaired notched impact performance.

### SUMMARY OF THE INVENTION

It was therefore an object of the present invention to provide a laser sinter powder which has better resistance to the thermal stresses arising during laser sintering, and has better aging properties, and therefore has better recyclability.

Surprisingly, it has now been found that when polyamides are treated with metal salts of weak acids and with fatty acid derivatives it is possible to produce sinter powders which can be used in laser sintering to produce moldings which, when compared with moldings composed of conventional sinter powders, are markedly less susceptible to the thermal stresses encountered. This permits, for example, a marked reduction in the rate of addition of fresh material, i.e. in the amount of unused powder which has to be added when using recycled powder. It is particularly advantageous for the amount which has to be replaced to be only the amount consumed by the construction of moldings, and this can (almost) be achieved using the powder of the invention.

### DETAILED DESCRIPTION OF THE INVENTION

The present invention therefore provides a sinter powder for selective laser sintering which comprises at least one polyamide and at least one metal salt, and also a fatty acid derivative.

The present invention also provides a process for producing sinter powder of the invention, which comprises mixing at least one polyamide powder with metal salt particles to give a sinter powder, either in a dry process or—in another embodiment—in the presence of a solvent in which the metal salts have at least low solubility, and then in turn removing the dispersion medium or solvent. Clearly, in both embodiments the melting points of the metal salts to be used have to be above room temperature. It may be necessary to mill the metal salts prior to incorporation within the dry blend, in order to provide a sufficiently fine powder.

The fatty acid derivative is likewise incorporated by these two methods, and this incorporation may take place simultaneously, or else in succession, and using different methods.

The present invention also provides moldings produced by laser sintering which comprise metal salt and a fatty acid derivative and at least one polyamide.

An advantage of the sinter powder of the invention is that moldings produced therefrom by laser sintering can also be produced from recycled material. This therefore permits access to moldings which have no depressions, even after repeated reuse of the excess powder. A phenomenon often arising alongside the depressions is a very rough surface, due to aging of the material. The moldings of the invention reveal markedly higher resistance to these aging processes, and this is noticeable in low embrittlement, good tensile strain at break, and/or good notched impact performance.

Another advantage of the sinter powder of the invention is that it performs well when used as sinter powder even after heat-aging. This is readily possible because, for example, during the heat-aging of powder of the invention, surprisingly, no fall-off in recrystallization temperature can be detected, and indeed in many instances a rise in recrystallization temperature can be detected (the same also frequently applying to the enthalpy of crystallization). When, therefore, aged powder of the invention is used to form a structure the crystallization performance achieved is almost the same as when virgin powder is used. When the powder conventionally used hitherto is aged, it does not crystallize until the temperatures reached are markedly lower than for virgin powder, the result being that depressions arise when recycled powder is used to form structures.

Another advantage of the sinter powder of the invention is that it may be mixed in any desired amounts (from 0 to 100 parts) with a conventional laser sinter powder based on polyamides of the same chemical structure. The resultant powder mixture likewise shows better resistance than conventional sinter powder to the thermal stresses of laser sintering.

Surprisingly, it has also been found that, even on repeated reuse of the sinter powder of the invention, moldings produced from this powder have consistently good mechanical properties, in particular with regard to modulus of elasticity, tensile strength, density, and tensile strain at break.

The sinter powder of the invention is described below, as is a process for its production, but there is no intention that the invention be restricted thereto.

The inventive sinter powder for selective laser sintering comprises at least one polyamide and at least one metal salt of a weak acid, and at least one fatty acid derivative, preferably a fatty ester or a fatty amide. The polyamide present in the sinter powder of the invention is preferably a polyamide which has at least 8 carbon atoms per carboxamide group. The sinter powder of the invention preferably comprises at least one polyamide which has 9 or more carbon atoms per carboxamide group. The sinter powder very particularly preferably comprises at least one polyamide selected from nylon-6,12 (PA 612), nylon-11 (PA 11), and nylon-12 (PA 12).

The sinter powder of the invention preferably comprises polyamide whose median particle size is from 10 to 250 μm, preferably from 45 to 100 μm, and particularly preferably from 50 to 80 μm.

A particularly suitable powder for laser sintering is a nylon-12 sintering powder which has a melting point of from 185 to 189° C., preferably from 186 to 188° C., an enthalpy of fusion of 112±17 J/g, preferably from 100 to 125 J/g, and a freezing point of from 133 to 148° C., preferably from 139 to 143° C. The process for preparing the polyamides which can be used in the sintering powders of the invention is well-known and, for example in the case of nylon-12 preparation, can be found in the specifications DE 29 06 647, DE 35 10 687, DE 35 10 691, and DE 44 21 454, these being incorporated into the disclosure of the present invention by way of reference. The polyamide pellets needed can be purchased from various producers, an example being nylon-12 pellets with the trade name VESTAMID® supplied by Degussa AG.

The sinter powder of the invention preferably comprises, based on the entirety of the polyamides present in the powder, from 0.01 to 30% by weight of at least one metal salt, preferably from 0.1 to 20% by weight of metal salt, particularly preferably from 0.5 to 15% by weight of metal salt, and very particularly preferably from 1 to 10% by weight of metal salt, in each case preferably in the form of particles. The sinter powder of the invention also preferably comprises, based on the entirety of the polyamides present in the powder, from 0.01 to 30% by weight of at least one fatty acid derivative, preferably from 0.1 to 20% by weight of fatty acid derivative, particularly preferably from 0.5 to 15% by weight of fatty acid derivative, and very particularly preferably from 1 to 10% by weight of fatty acid derivative.

The sinter powder of the invention may comprise a mixture of metal salt particles, fatty acid derivative particles and polyamide particles, or else comprise polyamide particles or, respectively, polyamide powders in which fatty acid derivatives, for example fatty amide, fatty ester, or ethylenebisstearylamide (EBS) and metal salts are present. It is particularly preferable to incorporate the fatty acid derivative into the polymer and then the mixture with the metal salt in powder form. If the proportion of the entirety of the additives composed of metal salt and fatty acid derivative, based on the entirety of the polyamides present in the powder, is less than 0.01% by weight, the desired effect of thermal stability and resistance to yellowing is markedly reduced. If the proportion of the entirety of the additives consisting of metal salt and fatty acid derivative additives, based on the entirety of the polyamides present in the powder, is above 30% by weight, there is marked impairment of mechanical properties, e.g. tensile strain at break of moldings produced from these powders.

The metal salts present in the sinter powder of the invention are preferably metal salts of weak acids. Particular preference is given to using metal carbonates, for example sodium carbonate, calcium carbonate, or magnesium carbonate. These salts are very readily obtainable at low cost.

The fatty acid derivatives present in the sinter powder of the invention are preferably fatty esters or fatty amides, and very particularly preferably ethylenebisstearylamide (EBS), which can be purchased from Clariant as Licolub FA 1.

For applying the powder to the layer to be sintered it is advantageous if the metal salts and fatty acid derivatives encapsulate the polyamide grains in the form of very fine particles, and this can be achieved either via dry-mixing of finely powdered metal salts and fatty acid derivatives onto the polyamide powder, or by wet-mixing of polyamide dispersions in a solvent in which the metal salts and fatty acid derivatives have at least low solubility. The reason for this is that particles modified in this way have particularly good flowability, and there is no need, or very little need, for addition of flow aids. A combination of the two processes for the two additives is also possible. However, it is also possible to use powders into which metal salts and fatty acid derivatives have been incorporated by compounding in bulk, if another method is used to ensure flowability—e.g. application of a flow aid by mixing. Suitable flow aids are known to the person skilled in the art, examples being fumed aluminum oxide, fumed silicon dioxide, and fumed titanium dioxide.

Sinter powder of the invention may therefore comprise these, or else other, auxiliaries, and/or filler. Examples of these auxiliaries may be the abovementioned flow aids, e.g. fumed silicon dioxide, or else precipitated silicas. An example of a fumed silicon dioxide is supplied by Degussa AG with the product name Aerosil®, with various specifications. Sinter powder of the invention preferably comprises less than 3% by weight, with preference from 0.001 to 2% by weight, and very particularly preferably from 0.05 to 1% by weight, of these auxiliaries, based on the entirety of the polyamides present. Examples of the fillers may be glass particles, metal particles, or ceramic particles, e.g. solid or hollow glass beads, steel shot, or metal granules, or color pigments, e.g. transition metal oxides.

The filler particles here preferably have a median grain size which is smaller or approximately equal to that of the particles of the polyamides. The extent to which the median grain size d₅₀ of the fillers exceeds the median grain size d₅₀ of the polyamides should preferably be not more than 20%, with preference not more than 15%, and very particularly preferably not more that 5%. A particular limit of the particle size arises via the permissible overall height or layer thickness in the laser sintering apparatus.

Sinter powder of the invention preferably comprises less than 75% by weight, with preference from 0.001 to 70% by weight, particularly preferably from 0.05 to 50% by weight, and very particularly preferably from 0.5 to 25% by weight, of these fillers, based on the entirety of the polyamides present.

If the stated maximum limits for auxiliaries and/or fillers are exceeded, depending on the filler or auxiliary used, the result can be marked impairment of the mechanical properties of moldings produced using these sinter powders. Another possible result of exceeding these values is disruption of the intrinsic absorption of the laser light by the sinter powder, with the result that the powder concerned can no longer be used for selective laser sintering.

After heat-aging of the sinter powder of the invention, there is preferably no shift in its recrystallization temperature (recrystallization peak in DSC) and/or in its enthalpy of crystallization to values smaller than those for the virgin powder. Heat-aging here means exposure of the powder for from a few minutes to two or more days to a temperature in the range from the recrystallization temperature to a few degrees below the melting point. An example of typical artificial aging may take place at a temperature equal to the recrystallization temperature plus or minus approximately 5° C., for from 5 to 10 days, preferably for 7 days. Aging during use of the powder to form a structure typically takes place at a temperature which is below the melting point by from 1 to 15° C., preferably from 3 to 10° C., for from a few minutes to up to two days, depending on the time needed to form the particular component. In the heat-aging which takes place during laser sintering, powder on which the laser beam does not impinge during the formation of the layers of the three-dimensional object is exposed to temperatures of only a few degrees below melting point during the forming procedure in the forming chamber. Preferred sinter powder of the invention has, after heat-aging of the powder, a recrystallization temperature (a recrystallization peak) and/or an enthalpy of crystallization, which shift(s) to higher values. It is preferable that both the recrystallization temperature and the enthalpy of crystallization shift to higher values. A powder of the invention which in the form of virgin powder has a recrystallization temperature above 138° C. very particularly preferably has, in the form of recycled powder obtained by aging for 7 days at 135° C., a recrystallization temperature higher, by from 0 to 3 C, preferably from 0.1 to 1° C., than the recrystallization temperature of the virgin powder.

The sinter powders of the invention are easy to produce, preferably by the process of the invention for producing sinter powders of the invention. In this process, at least one polyamide is mixed with at least one metal salt, preferably with a powder of metal salt particles, and with at least one fatty acid derivative, preferably with a powder of fatty acid derivative particles. For example, a polyamide powder obtained by reprecipitation or milling may be mixed, after suspension or solution in organic solvent, or in bulk, with metal salt particles, or else the polyamide powder may be mixed in bulk with metal salt particles. In a preferred method for operating in a solvent, at least one metal salt or metal salt particles preferably at least to some extent dissolved or suspended in a solvent, and at least one fatty acid derivative likewise at least to some extent dissolved or at least suspended in a solvent, is/are mixed with a solvent which comprises polyamide, where the solvent comprising the polyamide comprises the polyamide in dissolved form and the laser sinter powder is obtained by precipitation of polyamide from the solution comprising metal salt and/or fatty acid derivative, or the solvent comprises the polyamide suspended in powder form and the laser sinter powder is obtained by removing the solvent.

In the simplest embodiment of the process of the invention, a very wide variety of metals may be used to achieve fine-particle mixing. For example, the method of mixing may be the application of finely powdered metal salts and/or fatty acid derivatives onto the dry polyamide powder by mixing in high-speed mechanical mixers, or wet mixing in low-speed assemblies—e.g. paddle dryers or circulating-screw mixers (known as Nauta mixers)—or via dispersion of the metal salts and/or of a fatty acid derivative and of the polyamide powder in an organic solvent and subsequent removal of the solvent by distillation. In this procedure it is advantageous for the organic solvent to dissolve or at least suspend the metal salts as well as the fatty acid derivatives, at least at low concentration, because the metal salts and fatty acid derivatives crystallize out in the form of very fine particles during drying, and encapsulate the polyamide grains. Examples of solvents suitable for this variant are lower alcohols having from 1 to 3 carbon atoms, and use may preferably be made of ethanol as solvent.

Both the metal salt and the fatty acid derivative may be added with the polymer in a dry blend or added in wet-mix-incorporated form. The addition may take place simultaneously or in succession. A combination of dry blend and wet-mix-incorporation is also possible. The combination of wet-mix-incorporation of the fatty acid derivative followed by application of the metal salt in a high-speed mixer is particularly preferred.

In one of these first variants of the process of the invention, the polyamide powder may in itself be a polyamide powder suitable as a laser sinter powder, fine metal salt particles and fatty acid derivative particles simply being admixed with this powder. The particles of the additives here preferably have a median grain size which is smaller or approximately equal to that of the particles of the polyamides. The extent to which the median grain size d₅₀ of the additive particles exceeds the median grain size d₅₀ of the polyamides should preferably be not more than 20%, with preference not more than 15%, and very particularly preferably not more than 5%. A particular limit of the grain size arises via the permissible overall height or layer thickness in the laser sintering apparatus.

It is also possible to mix conventional sinter powders with sinter powders of the invention. This method can produce sinter powder with an ideal combination of mechanical and optical properties. The process for producing these mixtures may be found in DE 34 41 708, for example.

In another version of the process, an incorporative compounding process is used to mix one or more metal salts and one or more fatty acid derivatives with a, preferably molten, polyamide, and the resultant polyamide comprising additive is processed by (low-temperature) grinding or reprecipitation, to give laser sinter powder. The compounding usually gives pellets which are then processed to give sinter powder. Examples of methods for this conversion are milling or reprecipitation. The process variant in which the metal salts and fatty acid derivatives are incorporated by compounding has the advantage, when compared with the simple mixing process, of achieving more homogeneous dispersion of the metal salts and fatty acid derivatives in the sinter powder.

In this case a suitable flow aid, such as fumed aluminum oxide, fumed silicon dioxide, or fumed titanium dioxide, is added to the precipitated or low-temperature-ground powder, to improve flow performance.

In another, preferred variant of the process, the metal salt and/or the fatty acid derivatives is/are admixed with an ethanolic solution of polyamide before the process of precipitation of the polyamide is complete. This type of precipitation process has been described by way of example in DE 35 10 687 and DE 29 06 647. This process may be used, for example, to precipitate nylon-12 from an ethanolic solution through controlled cooling which follows a suitable temperature profile. In this procedure the metal salts and fatty acid derivatives likewise give fine-particle encapsulation of the polyamide grains, as described above for the suspension variant. For a detailed description of the precipitation process, see DE 35 10 687 and/or DE 29 06 647.

The person skilled in the art may also utilize this variant of the process in a modified form on other polyamides, the selection of polyamide and solvent being such that the polyamide dissolves in the solvent at an elevated temperature, and such that the polyamide precipitates out from the solution at a lower temperature and/or on removal of the solvent. The corresponding polyamide laser sinter powders of the invention are obtained by adding metal salts and/or fatty acid derivatives, preferably in the form of particles, to this solution, and then drying.

Examples of metal salts which may be used are the salts of a weak acid, particularly metal carbonates, especially sodium carbonate, potassium carbonate or magnesium carbonate, these being commercially available products and can be purchased, for example, from the company Fluka or the company Merck.

The fatty acid derivative used may comprise fatty esters or fatty amides, such as ethylenebisstearylamide (EBS), or else erucamide. These, too, are commercially available products and may be purchased from Clariant as Licolub FA1 or from Cognis as Loxamid E.

To improve processability, or for further modification of the sinter powder, this may be provided with additions of inorganic color pigments, e.g. transition metal oxides, stabilizers, e.g. phenols, in particular sterically hindered phenols, flow aids, e.g. fumed silicas, or else filler particles. The amount of these substances added to the polyamides, based on the total weight of the polyamides in the sinter powder, is preferably such as to comply with the concentrations given for fillers and/or auxiliaries for the sinter powder of the invention.

The present invention also provides processes for producing moldings by selective laser sintering, using sinter powders of the invention in which polyamide and metal salts and fatty acid derivatives, preferably in particulate form, are present. The present invention in particular provides a process for producing moldings by selective laser sintering of a metal-salt and fatty-acid-derivative-containing precipitated powder based on a nylon-12 which has a melting point of from 185 to 189° C., an enthalpy of fusion of 112±17 J/g, and a freezing point of from 136 to 145° C., the use of which is described in U.S. Pat. No. 6,245,281.

These processes are well-known, and are based on the selective sintering of polymer particles, where layers of polymer particles are briefly exposed to laser light, with the result that the polymer particles which have been exposed to the laser light become bonded to one another. Three-dimensional objects are produced by successive sintering of layers of polymer particles. Details of the selective laser sintering process are found by way of example in the specifications U.S. Pat. No. 6,136,948 and WO 96/06881.

The moldings of the invention, produced by selective laser sintering, comprise a polyamide in which metal salt and fatty acid derivative are present. The moldings of the invention preferably comprise at least one polyamide which has at least 8 carbon atoms per carboxamide group. Moldings of the invention very particularly preferably comprise at least one nylon-6,12, nylon-11, and/or one nylon-12, and at least one metal salt and at least one fatty acid derivative.

The metal salt present in the molding of the invention is the salt of a weak acid, particularly a metal carbonate. The metal salt is preferably calcium carbonate or sodium carbonate. The molding of the invention preferably comprises, based on the entirety of the polyamides present in the molding, from 0.01 to 30% by weight of metal salts, preferably from 0.1 to 20% by weight, particularly preferably from 0.5 to 15% by weight, and very particularly preferably from 1 to 10% by weight.

Moreover, the molding of the invention comprises, based on the entirety of the polyamides present in the molding, from 0.01 to 30% by weight of fatty acid derivatives, with preference from 0.1 to 20% by weight, particularly preferably from 0.5 to 15% by weight, and very particularly preferably from 1 to 10% by weight.

Additionally, the moldings may further comprise fillers and/or auxiliaries, e.g. heat stabilizers and/or antioxidants, e.g. sterically hindered phenol derivatives. Examples of fillers may be glass particles, ceramic particles, and also metal particles, such as iron shot, or appropriate hollow spheres. The moldings of the invention preferably comprise glass particles, very particularly preferably glass beads. Moldings of the invention preferably comprise less than 3% by weight, with preference from 0.001 to 2% by weight, and very particularly preferably from 0.05 to 1% by weight, of these auxiliaries, based on the entirety of the polyamide present. Moldings of the invention also preferably comprise less than 75% by weight, with preference from 0.001 to 70% by weight, particularly preferably from 0.05 to 50% by weight, and very particularly preferably from 0.5 to 25% by weight, of these fillers, based on the entirety of the polyamides present.

Another particular method of producing the moldings of the invention uses a sinter powder of the invention in the form of aged material (aging as described above), where neither the recrystallization peak nor the enthalpy of crystallization is smaller than those of the unaged material. Preference is given to the use of a molding of the invention which uses an aged material which has a higher recrystallization peak and a higher enthalpy of crystallization than the unaged material. Despite the use of recycled powder, the moldings have properties almost the same as those of moldings produced from virgin powder.

The examples below are intended to describe the sinter powder of the invention, and also its use, but there is no intention that the invention be restricted thereto.

The BET surface area determination carried out in the examples below complied with DIN 66131. The bulk density was determined using an apparatus to DIN 53466. The values measured for laser scattering were obtained on a Malvern Mastersizer S, Version 2.18.

Having generally described this invention, a further understanding can be obtained by reference to certain specific examples which are provided herein for purposes of illustration only, and are not intended to be limiting unless otherwise specified.

### EXAMPLES

### Example 1

### Incorporation of Sodium Carbonate by Reprecipitation

40 kg of unregulated PA 12 prepared by hydrolytic polymerization (the preparation of this polyamide being described by way of example in DE 21 52 194, DE 25 45 267, or DE 35 1 0690), with relative solution viscosity η_{rel.} of 1.61 (in acidified m-cresol) and having an end group content of 72 mmol/kg of COOH and, respectively, 68 mmol/kg of NH₂ were heated to 145° C. within a period of 5 hours in a 0.8 m³ stirred tank (tank: diameter=90 cm and height=170 cm) with 0.3 kg of IRGANOX® 1098, 0.8 kg of Loxamid E and 0.8 kg of sodium carbonate, and also 350 L of ethanol, denatured with 2-butanone and 1% water content, and were held at this temperature for 1 hour, with stirring (blade stirrer, diameter=42 cm, rotation rate=91 rpm). The jacket temperature was then reduced to 120° C., and the internal temperature was reduced to 120° C. at a cooling rate of 45 C/h, using the same stirrer rotation rate. From this juncture onward, the jacket temperature was maintained at from 2 to 3 C below the internal temperature, using the same cooling rate. The internal temperature was reduced to 117° C., using the same cooling rate, and then it was held constant for 60 minutes. The internal temperature was then reduced to 111° C., using a cooling rate of 40 C/h. At this temperature the precipitation began, which was detectable via evolution of heat. After 25 minutes the internal temperature decreased, indicating the end of the precipitation. After the suspension was cooled to 75° C., the suspension was transferred to a paddle dryer. The ethanol was distilled off from the material at 70° C. and 400 mbar, with stirring, and the residue was then further dried at 20 mbar and 85C. for 3 hours. A sieve analysis was performed on the resultant product, the results of which are presented in Table 1.

### Example 2

### Incorporation of Sodium Carbonate and Erucic Acid Amide by Compounding and Reprecipitation

40 kg of unregulated PA 12 prepared by hydrolytic polymerization with a relative solution viscosity η_{rel.} of 1.61 (in acidified m-cresol) and with an end group content of 72 mmol/kg of COOH and, respectively, 68 mmol/kg of NH₂ were extruded with 0.3 kg of IRGANOX® 245 and 0.8 kg of sodium carbonate and 0.4 kg of erucic acid amide (Loxamid E) at 225° C. in a twin-screw compounder (Bersttorf ZE25), and strand-pelletized. The temperature of this compounded material was then reduced to 145° C. within a period of 5 hours in a 0.8 m³ stirred tank (tank: diameter=90 cm and height=170 cm) with 350 L of ethanol, denatured with 2-butanone and 1% water content, and was held at this temperature for 1 hour, with stirring (blade stirrer: diameter=42 cm and rotation rate=91 rpm). The jacket temperature was then reduced to 120° C., and the internal temperature was reduced to 120° C. at a cooling rate of 45 C/h, using the same stirrer rotation rate. From this juncture onward, the jacket temperature was maintained at from 2 to 3 C below the internal temperature, using the same cooling rate. The internal temperature was reduced to 117° C., using the same cooling rate, where it remained constant for 60 minutes. The internal temperature was then further reduced to 111° C., using a cooling rate of 40 C/h. At this temperature the precipitation began, where it was detectable via the evolution of heat. After 25 minutes the internal temperature fell, which indicated the end of the precipitation. After cooling of the suspension to 75° C., the suspension was transferred to a paddle dryer. The ethanol was distilled off from the material at 70° C. and 400 mbar, with stirring, and the residue is then further dried at 20 mbar and 85° C. for 3 hours. A sieve analysis was performed on the resultant product, the results of which are presented in Table 1.

### Example 3

### Incorporation of Calcium Carbonate and N,N′-bisstearoylethylene Diamine in Ethanolic Suspension

The procedure is as described in Example 1, but the metal salt and the fatty acid amide were not added at the start, rather 0.4 kg of calcium carbonate and 0.4 kg of N,N′-bisstearoylethylene diamine (Licolub FA 1) were added at 75° C. to the freshly precipitated suspension in the paddle dryer, once the precipitation is complete. Drying and further work-up took place as described in Example 1. A sieve analysis was performed on the resultant product, the results of which are presented in Table 1.

### Example 4

### Incorporation of Magnesium Carbonate and N,N′-bisstearoylethylene Diamine in Ethanolic Suspension

The procedure is as described in Example 3, with the exception that 0.4 kg of magnesium carbonate and 0.8 kg of N,N′-bisstearoylethylene diamine (Licolub FA 1) were added at 75° C. to the freshly precipitated suspension in the paddle dryer, and the drying process occurred as described in Example 1. A sieve analysis was performed on the resultant product, the results of which are presented in Table 1.

### Example 5

### Incorporation of Magnesium Carbonate and N,N′-bisstearoylethylene diamine in Ethanolic Suspension and in the Dry Blend:

The procedure is as described in Example 3, but 0.4 kg of N,N′-bisstearoylethylene diamine (Licolub FA 1) (1% by weight) is added at 75° C. to the freshly precipitated suspension in the paddle dryer, and the drying process occurred as described in Example 1. Subsequent to drying, 0.8 kg of magnesium carbonate was then added to the powder in the mixer (Henschel mixer). A sieve analysis was performed on the resultant product, the results of which are presented in Table 1.

### Comparative Example 1

40 kg of unregulated PA 12 prepared by hydrolytic polymerization, with a relative solution viscosity η_{rel.} of 1.61 (in acidified m-cresol) and with an end group content of 72 mmol/kg of COOH and, respectively, 68 mmol/kg of NH₂ were heated to 145° C. within a period of 5 hours in a 0.8 m³ stirred tank (tank diameter=90 cm and height=170 cm) with 0.3 kg of IRGANOX® 1098 in 350 L of ethanol, denatured with 2-butanone and 1% water content, and held at this temperature for 1 hour, with stirring (blade stirrer, diameter=42 cm and rotation rate=91 rpm). The jacket temperature was then reduced to 120° C., and the internal temperature was reduced to 120° C. at a cooling rate of 45 C/h, using the same stirrer rotation rate. From this juncture onward, the jacket temperature was maintained at from 2 to 3 C below the internal temperature, while using the same cooling rate. The internal temperature was reduced to 117° C., using the same cooling rate, and then held constant for 60 minutes. The internal temperature was then reduced to 111° C., using a cooling rate of 40 C/h. At this temperature the precipitation began, which was detectable via the evolution of heat. After 25 minutes the internal temperature decreased, which indicated the end of the precipitation. After cooling of the suspension to 75° C., the suspension was transferred to a paddle dryer. The ethanol was distilled off from the material at 70° C. and 400 mbar, with stirring, and the residue was then further dried at 20 mbar and 85° C. for 3 hours. A sieve analysis was performed on the resultant product, the results of which are presented in Table 1.

TABLE 1
Sieve analysis data.

| | | | Laser Scattering | | |
|---|---|---|---|---|---|
| | BET | Bulk Density | d(10%) | d(50%) | d(90%) |
| Example No | m²/g | g/L | μm | μm | μm |
| 1 | 5.2 | 442 | 46 | 67 | 102 |
| 2 | 5.3 | 433 | 39 | 61 | 81 |
| 3 | 6.4 | 433 | 45 | 58 | 83 |
| 4 | 5.0 | 455 | 41 | 61 | 84 |
| 5 | 5.8 | 450 | 40 | 56 | 90 |
| Comp. Ex. 1 | 6.9 | 429 | 42 | 69 | 91 |

Additional Processing and Aging Tests

All of the specimens from Examples 1 to 5 and Comparative Example 1 were treated with 0.1% by weight of AEROSIL 200 for 1 minute in a CM50 D Mixaco mixer at 150 rpm. Portions of the powders obtained from Examples 1 to 5 and Comparative Example 1 were aged at 35° C. for 7 days in a vacuum drying cabinet and then, with no addition of fresh powder, were used to form a structure on a laser sintering machine. Mechanical properties of the components were determined by tensile testing to EN ISO 527 (Table 2). Density was determined by a simplified internal method. For this, the test specimens produced to ISO 3167 (multipurpose test specimens) were measured, and these measurements were used to calculate the volume, and the weight of the test specimens was determined, and the density was calculated from volume and weight. Components and test specimens to ISO 3167 were also produced from virgin powder (unaged powder) for comparative purposes. In each case, an EOSINT P360 laser sintering machine from the company EOS GmbH was used for the production process.

TABLE 2
Mechanical properties of parts prepared from
unaged and artificially aged powders.

| | | Tensile | Modulus of | |
|---|---|---|---|---|
| Part Prepared from | Aged/ | strain | Elasticity, | Density, |
| Powder Described in | Unaged | at break, % | N/mm² | g/cm³ |
| Example 1 | AGED | 15.5 | 1633 | 0.94 |
| Example 1 | UNAGED | 18.4 | 1741 | 0.95 |
| Example 2 | AGED | 20.3 | 1599 | 0.93 |
| Example 3 | AGED | 20.9 | 1727 | 0.95 |
| Example 4 | AGED | 17.0 | 1680 | 0.93 |
| Example 5 | AGED | 19.6 | 1653 | 0.94 |
| Comparative | AGED | 9.4 | 244 | 0.53 |
| Example 1 | | | | |
| Comparative | UNAGED | 21.2 | 1641 | 0.96 |
| Example 1 | | | | |

As can be seen from Table 2, the admixture of metal salts and fatty acid derivatives achieves the improvements described below. The result of the modification is that the density after aging remains approximately at the level for a virgin powder. Mechanical properties, such as tensile strain at break and modulus of elasticity, also remain at a high level despite aging of the powder.

Recycling Test

A powder produced as in Example 5, and a comparative powder produced as in Comparative Example 1, in each case with no artificial aging, were also recycled on a laser sintering machine (EOSINT P360 from the company EOS GmbH). This means that powder which has been used but not sintered is reused in the next forming process. After each pass, the reused powder was supplemented by adding 20% of fresh, unused powder. The mechanical properties of the components were determined by tensile testing to EN ISO 527. Density was determined as described above by the simplified internal method. Table 2 lists the values measured on components obtained by recycling.

TABLE 3
Recycling data for powder which has been used in the sintering process, and
subsequently used in the next forming process

| | Material from example 5 | | | Comparative Example 1 | | |
|---|---|---|---|---|---|---|
| | | Modulus | | | Modulus | |
| | Component | of | | Component | of | Tensile |
| | density, | elasticity, | Tensile strain | density, | elasticity | strain at |
| | g/cm³ | MPa | at break, % | g/cm³ | MPa | break, % |
| 1^{st} pass | 0.93 | 1620 | 14.7 | 0.95 | 1603 | 17.8 |
| 3^{rd} pass | 0.93 | 1601 | 17.3 | 0.88 | 1520 | 15.2 |
| 6^{th} pass | 0.94 | 1709 | 17.8 | 0.8 | 1477 | 14.9 |

It is clearly seen from the data listed in Table 3 that even on the 6^{th} pass there is no deterioration in either the density or the mechanical properties of the component produced from a powder of the invention. In contrast, the density and the mechanical properties of the component produced from the powder as described in Comparative Example 1, deteriorates markedly as the number of passes increases.

In a further study of powder of the invention, DSC equipment (Perkin Elmer DSC 7) was used for DSC studies to DIN 53765, both on powder produced according to the invention and on specimens of components. The results of these studies are given in Table 4.

The components again comply with ISO 3167, and were obtained as described above. Characteristic features of the powders of the invention and, respectively, of components produced from the powder of the invention, are an enthalpy of fusion increased over that of the unmodified powder, and a markedly increased recrystallization temperature. There is also a rise in enthalpy of crystallization. The values relate to powder artificially aged as described above and, respectively, to components produced from this aged powder.

TABLE 4
Values from DSC measurements of components that
comprise powders described herein.

| | | 1st | | | 2nd |
|---|---|---|---|---|---|
| | | heating | Cooling | Cooling | heating |
| Component | | Enthalpy of | Recrystallization | Enthalpy of | Enthalpy |
| prepared from the | | fusion | peak | crystallization | of fusion |
| powder described | Aged/ | ΔH_{F}, | T_{CP}, | ΔH_{C}, | ΔH_{F}, |
| in | Unaged | J/g | ° C. | J/g | J/g |
| Ex. 1 | Aged | 115 | 143 | 71 | 72 |
| Ex. 2 | Aged | 108 | 145 | 68 | 76 |
| Ex. 3 | Aged | 98 | 139 | 68 | 73 |
| Ex. 4 | Aged | 92 | 141 | 70 | 71 |
| Ex. 5 | Aged | 105 | 140 | 72 | 75 |
| EX. 5^{a} | Aged | 101 | 142 | 69 | 75 |
| Comp. Ex. 1 | Aged | 88 | 131 | 58 | 60 |
| Comp. Ex. 1 | Unaged | 106 | 136 | 63 | 67 |

^{a}Material that was recycled from the 6^{th} pass.

As can be seen from the date in Table 4, the components composed of aged powder modified according to the invention have crystallinity properties similar to those of the components composed of an unaged powder, whereas the component composed of aged powder (prepared as described in Comp. Ex. 1) has markedly different properties. When recrystallization temperature and enthalpy of crystallization are considered, it can also be seen that the powder comprising metal salt and fatty acid derivative, when used as recycled powder, has the same, or even a higher, recrystallization temperature and enthalpy of crystallization when compared with the untreated virgin powder. In contrast, in the case of the untreated recycled powder, the recrystallization temperature and the enthalpy of crystallization are lower than those of the virgin powder.

Obviously, numerous modifications and variations on the present invention are possible in light of the above teachings. It is therefore to be understood that within the scope of the appended claims, the invention may be practiced otherwise than as specifically described herein.

The priority document of the present application, DE application 103 34 496.9, filed Jul. 29, 2003, is incorporated herein by reference.

1. A sinter powder for selective laser sintering, which comprises:
at least one polyamide;
at least one metal salt of a weak acid; and
at least one fatty acid derivative.

2. A sinter powder as claimed in claim 1, which further comprises:
a fatty acid derivative which comprises a fatty amide or fatty ester or an ethylenebisstearylamide.

3. A sinter powder as claimed in claim 1, which further comprises:
a polyamide which has at least 8 carbon atoms per carboxamide group.

4. A sinter powder as claimed in claim 1, wherein at least one polyamide is selected from the group consisting of nylon-6,12, nylon-11, nylon-12, and copolyamide mixtures thereof.

5. A sinter powder as claimed in claim 1, which further comprises:
0.01 to 30% by weight of metal salt and fatty acid derivative, which is based on the entirety of the polyamides present in the powder.

6. A sinter powder as claimed in claim 4, which further comprises:
0.5 to 15% by weight of metal salt and fatty acid derivative, which is based on the entirety of the polyamides present in the powder.

7. A sinter powder as claimed in claim 1, which further comprises:
a mixture of fine metal salt and fatty acid particles and polyamide particles.

8. A sinter powder as claimed in claim 1, which further comprises:
metal salts and fine particles of fatty acid derivatives incorporated within polyamide particles.

9. A sinter powder as claimed in claim 1, which further comprises:
fine metal salt particles and fatty acid derivatives incorporated within polyamide particles.

10. A sinter powder as claimed in claim 1, which further comprises:
fatty acid derivatives and metal salts incorporated within polyamide particles.

11. A sinter powder as claimed in claim 1, wherein the metal salts are metal carbonates.

12. A sinter powder as claimed in claim 1, wherein the powder has a recrystallization temperature and/or the enthalpy of crystallization of the powder that is about the same before and after heat-aging.

13. A sinter powder as claimed in claim 1, wherein the powder has a higher value of the recrystallization temperature and/or the enthalpy of crystallization shifts after heat-aging.

14. A sinter powder as claimed in claim 1, wherein at least one metal salt is selected from the group consisting of sodium carbonate, calcium carbonate, and magnesium carbonate.

15. A sinter powder as claimed in claim 1, which further comprises:
auxiliaries and/or filler.

16. A sinter powder as claimed in claim 12, which further comprises:
at least one flow aid as an auxiliary.

17. A sinter powder as claimed in claim 12, which further comprises:
glass particles as a filler.

18. A process for producing sinter powder as claimed in claim 1, which comprises:
mixing at least one polyamide with at least one metal salt and with at least one fatty acid derivative.

19. A process for producing sinter powder as claimed in claim 1, wherein at least one metal salt is a powder of a metal salt particle.

20. A process for producing sinter powder as claimed in claim 1, wherein at least one fatty acid derivative is a powder of a fatty acid derivative particle.

21. A process as claimed in claim 18, wherein at least one polyamide is obtained by:
reprecipitating or milling a suspension or a solution of at least one polyamide in an organic solvent.

22. A process for producing sinter powder as claimed in claim 1, which comprises:
compounding at least one metal salt and at least one fatty acid derivative into a melt of at least one polyamide.

23. A process for producing sinter powder as claimed in claim 1, which comprises:
mixing at least one metal salt or metal salt particles and a fatty acid derivative with a polyamide that is dissolved in a solvent to form a solution; and
precipitating said sinter powder from the solution.

24. A process for producing sinter powder as claimed in claim 1, which comprises:
mixing at least one metal salt or metal salt particles and at least one fatty acid derivative with a polyamide that is suspended in powder form in a solvent to form a suspended solution; and
evaporating said solvent.

25. A process for producing sinter powder as claimed in claim 1, which comprises at least one of A; B; C and D; and E and F:
A) reprecipitating or milling a suspension or a solution of at least one polyamide in an organic solvent;
B) compounding at least one metal salt and at least one fatty acid derivative into a melt of at least one polyamide;
C) mixing at least one metal salt or metal salt particles and a fatty acid derivative with a polyamide that is dissolved in a solvent to form a solution; and
D) precipitating said sinter powder from the solution;
E) mixing at least one metal salt or metal salt particles and at least one fatty acid derivative with a polyamide that is suspended in powder form in a solvent to form a suspended solution; and
F) evaporating said solvent.

26. A process for producing moldings, which comprises:
selectively laser sintering a sinter powder as claimed in claim 1.

27. A molding produced by laser sintering, which comprises a laser sinter powder which comprises:
at least one metal salt and at least one fatty acid derivative and at least one polyamide.

28. The molding as claimed in claim 27, wherein at least one polyamide has at least 8 carbon atoms per carboxamide group.

29. The molding as claimed in claim 27, which comprises nylon-6,12, nylon-11, and/or nylon-12.

30. The molding as claimed in claim 28, which comprises nylon-6,12, nylon-11, and/or nylon-12.

31. The molding as claimed in claim 27, wherein at least one metal salt is present in an amount of from 0.01 to 30% by weight and at least one fatty acid derivative in an amount of from 0.01 to 30% by weight, both of which are based on the entirety of the polyamides present in the molding.

32. The molding as claimed in claim 27, wherein at least one metal salt is present in an amount of from 0.5 to 15% by weight and at least one fatty acid derivative in an amount of from 0.5 to 15% by weight, both of which are based on the entirety of the polyamides present in the molding.

33. The molding as claimed in claim 27, wherein the metal salt is a sodium carbonate, a calcium carbonate, or a magnesium carbonate.

34. The molding as claimed in claim 27, which further comprises fillers.

35. The molding as claimed in claim 27, which further comprises glass particles.

36. The molding as claimed in claim 27, wherein the laser sinter powder has a recrystallization temperature and/or the enthalpy of crystallization of the powder that is about the same before and after heat-aging.

37. The molding as claimed in claim 27, wherein the laser sinter powder has a higher value of the recrystallization temperature and/or the enthalpy of crystallization shifts after heat-aging.
